(19) United States
(12) Patent Application Publication
(10) Pub. No.: US 2021/0067754 A1
(43) Pub. Date: Mar. 4, 2021

(54) METHOD FOR CONTROLLING DISPLAY SYSTEM, AND PROJECTOR

(71) Applicant: SEIKO EPSON CORPORATION, Tokyo (JP)

(72) Inventors: Toshiki FUJIMORI, Chino-shi (JP); Eiji IZUMIDA, Matsumoto-shi (JP)

(21) Appl. No.: 17/005,406

(22) Filed: Aug. 28, 2020

(30) Foreign Application Priority Data
Aug. 29, 2019 (JP) 2019-156428

(51) Int. Cl. H04N 9/31; G06F 3/14; G06F 3/0484

(52) U.S. Cl. CPC H04N 9/3194; H04N 9/3179; G06F 3/04847; G06F 3/1423

(57) ABSTRACT

There is provided a projector including a display section that displays a first image according to the video signal outputted from the output apparatus on a projection surface, a connection section that couples an external apparatus to the projector, a storage that stores at least setting information representing a setting on display of the first image, an operation accepting section that accepts operation of updating the setting information, and a controller. The controller operates in one of a normal action mode and an external control mode. In the external control mode, the controller transmits the setting information to the external apparatus, and when operation is performed on the operation accepting section, the controller transmits operation information representing the operation to the external apparatus.

The present application is based on, and claims priority from JP Application Serial Number 2019-156428, filed Aug. 29, 2019, the disclosure of which is hereby incorporated by reference herein in its entirety.

### BACKGROUND

### 1. Technical Field

The present disclosure relates to a method for controlling a display system, and a projector.

### 2. Related Art

There is a project having a normal action mode and an external control mode as action modes for a variety of settings, such as a setting on a display image. The normal action mode is an action mode in which a setting screen for an image to be displayed on a projection surface, such as a screen, is so displayed as to be superimposed on the image based on an OSD (on-screen display) function, an operation accepting section of the main body of the projector accepts operation of changing the settings, and the settings are changed in accordance with the content of the operation. The external control mode is an action mode in which an external apparatus coupled to the projector displays a setting screen, an operation accepting section of the external apparatus accepts the operation of changing the settings, the external apparatus transmits the content of the operation to the projector, and the projector changes the settings in accordance with the content of the operation transmitted from the external apparatus. JP-A-2013-80141 discloses a projector that does not accept operation performed on the operation accepting section of the main body of the projector when the projector operates in the external control mode.

The projector of the related art, however, exclusively selects the normal action mode or the external control mode. The projector of the related art therefore has a problem of inability to accept operation via the operation accepting section of the main body when the projector operates in the external control mode.

### SUMMARY

A method for controlling a display system according to an aspect of the present disclosure is a method for controlling a display system including a projector that displays a first image according to a video signal outputted from an output apparatus on a projection surface and includes an operation accepting section that accepts a user's operation; and an external apparatus including a display section and coupled to the projector. The projector stores at least setting information representing a setting on display of the first image. The projector operates in one of a first mode in which a first screen that allows the user to view or update the setting information is displayed on the projection surface in accordance with the setting information and the setting information is updated in accordance with first operation performed on the operation accepting section and a second mode in which the setting information is updated in accordance with an update instruction received from the external apparatus. In the second mode, the projector transmits the setting information to the external apparatus, and when second operation is performed on the operation accepting section, the projector transmits operation information representing the second operation to the external apparatus. The external apparatus displays, in accordance with the setting information received from the projector, a second screen that allows the user to view or update the setting, generates the update instruction in accordance with the second operation indicated by the operation information received from the projector, and transmits the update instruction to the projector.

A projector according to another aspect of the present disclosure includes a connection section that couples an external apparatus and an output apparatus that outputs a video signal to the projector, a display section that displays a first image according to the video signal outputted from the output apparatus coupled to the connection section on a projection surface, a storage that stores at least setting information representing a setting on display of the first image, an operation accepting section that accepts operation of updating the setting information, and a controller that operates in one of a first mode in which a first screen that allows a user to view or update the setting information is displayed on the projection surface and the setting information is updated in accordance with first operation accepted by the operation accepting section and a second mode in which the setting information is updated in accordance with an update instruction received from the external apparatus. In the second mode, the controller transmits the setting information to the external apparatus to cause the external apparatus to display a second screen that allows the user to view or update the setting information, and when second operation is performed on the operation accepting section, the controller transmits operation information representing the second operation to the external apparatus to cause the external apparatus to generate and return the update instruction according to the second operation.

### BRIEF DESCRIPTION OF THE DRAWINGS

FIG. 1 is schematic view showing the exterior appearance of a display system including a projector according to an embodiment of the present disclosure.

FIG. 2 is a block diagram showing an example of the hardware configuration and functional configuration of the projector according to the embodiment of the present disclosure.

FIG. 3 shows an example of a setting screen displayed by the projector according to the embodiment of the present disclosure.

FIG. 4 is a flowchart showing the procedure of processes carried out in an external control mode by a controller of the projector according to the embodiment of the present disclosure.

FIG. 5 is a block diagram showing an example of the hardware configuration and functional configuration of an external apparatus coupled to the projector according to the embodiment of the present disclosure.

FIG. 6 is a flowchart showing the procedure of processes carried out by a controller of the external apparatus in the embodiment of the present disclosure.

FIG. 7 describes a variation.

FIG. 8 describes another variation.

### DESCRIPTION OF EXEMPLARY EMBODIMENTS

An embodiment will be described below with reference to the drawings. In the drawings, the dimension and scale of each portion differ from actual values as appropriate. Further, a variety of technically preferable restrictions are imposed on the embodiment described below, but the embodiment is not limited to the form described below.

### 1. Overview of Display System

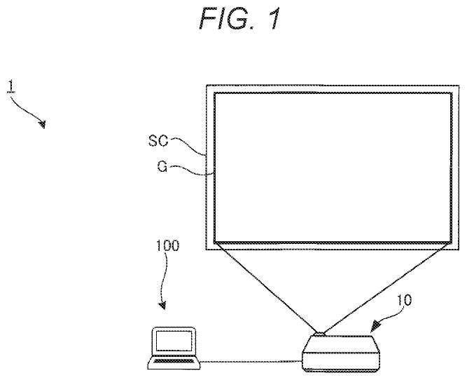

FIG. 1 schematically shows the exterior appearance of a display system 1, which includes a projector 10, according to an embodiment of the present disclosure. The display system 1 is a projection system and includes an external apparatus 100 coupled to the projector 10 in addition to the projector 10. Although not shown in FIG. 1, not only the external apparatus 100 but an output apparatus that outputs a video signal to the projector 10 are coupled to the projector 10. Specific examples of the output apparatus coupled to the projector 10 may include a media player, a personal computer, and a DVD (digital versatile disk) player. The projector 10 projects an image G according to the video signal outputted from the output apparatus on a projection surface SC, such as a screen. The projector 10 thus displays the image G. The image G is an example of a first image displayed by the projector 10 on the projection surface SC. Examples of the location at which the projection surface SC is installed may include a wall, a floor, and a table. Examples of the location at which the projector 10 is installed may include a ceiling, a wall, a floor, a table, and a dedicated installation stand.

The projector 10 has the OSD function and has two action modes, a normal action mode and an external control mode. The normal action mode is an example of a first mode out of the two action modes of the projector 10, and the external control mode is an example of a second mode out of the two action modes of the projector 10. In the normal action mode, the projector 10 displays a setting screen that allows a user to view or update a variety of settings of the projector 10 on the projection surface SC with the setting screen superimposed on the image G by using the OSD function. The setting screen displayed by the projector 10 that operates in the normal action mode on the projection surface SC is an example of a first screen displayed by the projector 10 on the projection surface SC. The user of the projector 10 can change the settings of the projector 10 by operating an operation accepting section of the projector 10 while referring to the setting screen displayed on the projection surface SC. The settings at least include, for example, image quality settings, such as the brightness, contrast, and color depth, video image settings, such as the input resolution, aspect ratio, and display position, and settings on the display of the image G, such as geometric distortion correction and zoom setting. The settings to be viewed or changed by the user via the setting screen may include, for example, settings on sound reproduced in synchronization with the display of the image G and settings on communication with the external apparatus 100 in addition to the settings on the display of the image G.

In the external control mode, the external apparatus 100 having been coupled to the projector 10 is used to view or change the settings of the projector 10. The external apparatus 100 is, for example, a personal computer. Although not shown in detail in FIG. 1, the external apparatus 100 includes a display section that displays a setting screen that allows the user to view or change the settings of the projector 10 and an operation accepting section that accepts the user's operation. The setting screen displayed by the external apparatus 100 on the display section is an example of a second screen in the present embodiment. The external apparatus 100 accepts the operation of changing the setting of the projector 10 via the operation accepting section of the external apparatus 100 and changes the settings of the projector 10 in accordance with the content of the operation. In the situation in which the projector 10 is used to make a presentation or any other action, the setting screen displayed on the projection surface SC interferes with the presentation, and it is therefore preferable that the projector 10 operates in the external control mode.

The related-art projector having the two action modes, the normal action mode and the external control mode, is configured not to accept the user's operation via the operation accepting section of the projector when the projector operates in the external control mode, that is, not to change the settings, even when the operation of changing the settings is performed on the operation accepting section, in accordance with the operation. In contrast, the projector 10 and the external apparatus 100 in the present embodiment are configured to accept, when the operation of changing the settings is performed on the operation accepting section of the projector 10 that operates in the external control mode, accepts the operation. The following description will be made primarily on the projector 10 and the external apparatus 100.

### 2. Configuration of Projector

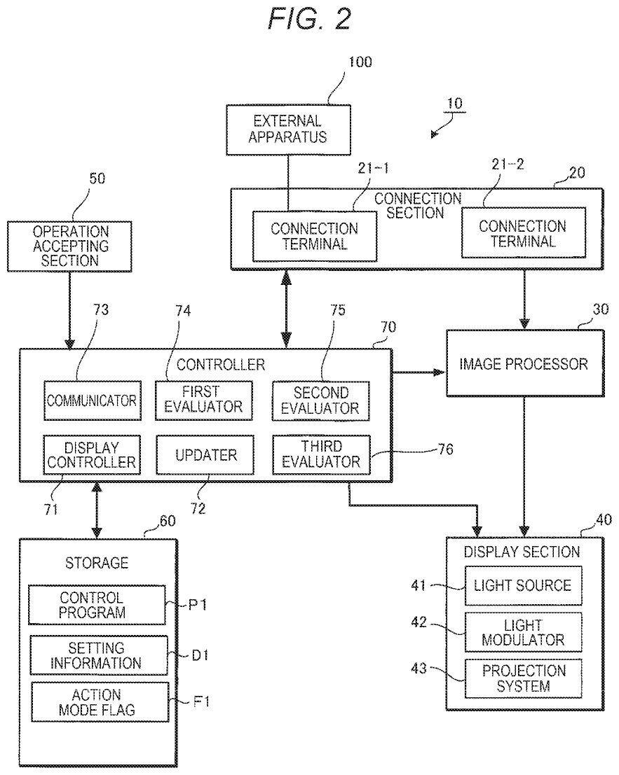

FIG. 2 is a block diagram showing an example of the hardware configuration and functional configuration of the projector 10. The projector 10 includes a connection section 20, an image processor 30, a display section 40, an operation accepting section 50, a storage 60, and a controller 70, as shown in FIG. 2.

The connection section 20 has a connection terminal 21-1 and a connection terminal 21-2. The external apparatus 100 is connected to the connection terminal 21-1, as shown in FIG. 2. A specific example of the connection terminal 21-1 may be a USB (universal serial bus) terminal. Although not shown in detail in FIG. 2, the output apparatus is connected to the connection terminal 21-2. Specific examples of the connection terminal 21-2 may include an HDMI (registered trademark) terminal, a USB (universal serial bus) terminal, and a micro-USB terminal. The projector 10 in the present embodiment has one connection terminal 21-1 for connection of the external apparatus 100 and may instead have a plurality of connection terminals 21-1. The same holds true for the connection terminal 21-2 for connection of the output apparatus, and the projector 10 may be provided with a plurality of connection terminals 21-2.

The image processor 30 is a circuit that performs a variety of types of image processing on the video signal provided from the connection section 20 to generate display information and inputs the generated display information to the display section 40. The image processor 30 includes, for example, a frame memory that is not shown. The image processor 30 develops the video signal provided from the connection section 20 in the frame memory, performs a variety of processes, such as resolution conversion, resizing, and distortion correction, on the developed video signal as appropriate to generate display information, and inputs the generated display information to the display section 40.

The display section 40 is a projection apparatus that projects image light according to the display information onto the projection surface SC to display the image G. The display section 40 includes a light source 41, a light modulator 42, and a projection system 43.

The light source 41 includes, for example, a halogen lamp, a xenon lamp, an ultrahigh-pressure mercury lamp, an LED (light emitting diode), or a laser light source. The light source 41 outputs, for example, red light, green light, and blue light or outputs white light. When the light source 41 outputs white light, the light outputted from the light source 41 passes through an optical integration system that is not shown, which reduces variation in the luminance distribution of the light, and the resultant light is separated by a color separation system that is not shown into red light, green light, and blue light, which are incident on the light modulator 42. The light modulator 42 includes three light modulation devices provided in correspondence with the red light, the green light, and the blue light. The three light modulation devices are each formed, for example, of a transmissive liquid crystal panel, a reflective liquid crystal panel, or a digital mirror device. The three light modulation devices modulate the red light, the green light, and the blue light, respectively, to generate color image light fluxes. The color image light fluxes generated by the light modulator 42 are combined with one another by a light combining system that is not shown into full-color image light. The projection system 43 focuses and projects the full-color image light on the projection surface SC. The projection system 43 is an optical system including at least one projection lens and may further include a zooming lens, a focusing lens, or any other lens.

The operation accepting section 50 includes a variety of operation elements, such as cursor keys and an enter key, although not shown in detail in FIG. 2. When any of the operation elements is pressed or otherwise operated, the operation accepting section 50 provides the controller 70 with operation information representing the content of the operation irrespective of the action mode of the projector 10, that is, the normal action mode or the external control mode. The content of the user's operation performed on the operation accepting section 50 is thus transmitted to the controller 70. Operation performed on the operation accepting section 50 in the normal action mode is an example of first operation, and operation performed on the operation accepting section 50 in the external control mode is an example of second operation. The operation accepting section 50 may be formed of a touch panel.

The storage 60 is a storage device that stores an action mode flag F1, setting information D1, and a control program P1 executed by the controller 70. The setting information D1 is information representing the settings of the projector 10. The action mode flag F1 is information representing the action mode of the projector 10. The action mode flag F1 is set at “O” or “1”. The value “0” of the action mode flag F1 represents that the action mode of the projector 10 is the normal action mode. The value “1” of the action mode flag F1 represents that the action mode of the projector 10 is the external control mode. The action mode flag F1 is set at an initial value, which is “0”, for example, in response to a trigger that is powering-on of the projector 10. Although will be described later in detail, the action mode flag F1 and the setting information D1 form information that the controller 70 refers to or updates in the course of the execution of the control program P1. Although not shown in detail in FIG. 2, the storage 60 includes a volatile storage and a nonvolatile storage.

A volatile storage is a storage device that cannot hold stored information when no electric power is supplied to the storage device, whereas a nonvolatile storage is a storage device that can hold stored information even when no electric power is supplied to the storage device. An example of the volatile storage may be a RAM (random access memory). The volatile storage is used as a work area that stores information to be processed by the controller 70 and a work area where the controller 70 executes the control program P1. An example of the nonvolatile storage may be a hard disk drive. The nonvolatile storage stores the setting information D1 and the control program P1 in advance.

The controller 70 is a processing device having the function of controlling each portion of the projector 10 and the function of processing a variety of types of information. The controller 70 includes a processor, for example, a CPU (central processing unit). The controller 70 achieves a variety of functions including functional sections that will by described later by executing the control program P1 stored in the storage 60. The controller 70 may be formed of a single processor or a plurality of processors. Part or the entirety of the functions of the controller 70 may be achieved by hardware, such as a DSP (digital signal processor), an ASIC (application specific integrated circuit), a PLD (programmable logic device), and an FPGA (field programmable gate array). The controller 70 may be integrated with the image processor 30 described above.

When instructed by operation performed on the operation accepting section 50 to start execution of the control program P1, the controller 70 reads the control program P1 from the storage 60 and executes the control program P1. The controller 70 that operates in accordance with the control program P1 operates in one of the normal action mode and the external control mode. In more detail, the controller 70 operates in the normal action mode when the value of the action mode flag F1 is “0” and operates in the external control mode when the value of the action mode flag F1 is “1”. When the control program P1 is executed immediately after the projector 10 is powered on, the controller 70 operates in the normal action mode because the initial value of the action mode flag F1 is “0”. The controller 70 that operates in the normal action mode functions as a display controller 71, an updater 72, and a communicator 73 shown in FIG. 2. In contrast, the controller 70 that operates in the external control mode functions as the updater 72, the communicator 73, a first evaluator 74, a second evaluator 75, and a third evaluator 76 shown in FIG. 2.

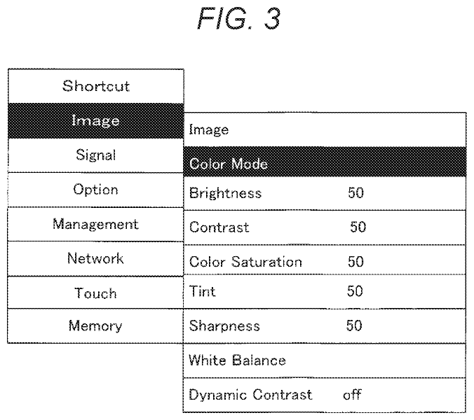

The display controller 71 generates display information representing, for example, that the setting screen shown in FIG. 3 is displayed by the OSD function in accordance with the setting information D1 and provides the display section 40 with the display information. The setting screen shown in FIG. 3 is thus displayed on the projection surface SC with the setting screen superimposed on the image G. The setting screen in the present embodiment is a screen showing setting items, such as Shortcut, Image, and Signal, arranged in the form of a list and allows the user to select a setting item to view and update more detailed setting items relating to the selected setting item, as shown in FIG. 3. FIG. 3 shows a case where the setting item Image has been selected. The user of the projector 10 can grasp the settings of the projector 10 that relate to the display of the image G and change the set content of a desired setting item by operating the operation accepting section 50. Since the controller 70 does not function as the display controller 71 in the external control mode, as described above, the controller 70 does not display the setting screen on the projection surface SC in the external control mode.

The updater 72 updates the setting information D1 in accordance with the operation information received from the operation accepting section 50 in the normal action mode. For example, upon reception of operation information representing the operation of changing the value of a setting item Brightness, the updater 72 updates the value of the setting item Brightness in the setting information D1 in accordance with the operation information described above. In the external control mode, the updater 72 updates the setting information D1 in accordance with an update instruction transmitted from the external apparatus 100 to instruct update of the setting information D1.

The communicator 73 communicates with the external apparatus 100 connected to the connection section 20. In the normal action mode, the communicator 73 receives a control request that prompts switching the action mode to the external control mode from the external apparatus 100. The communicator 73 updates the value of the action mode flag F1 to “1” when the setting information D1 contains information representing that acceptance of the control request is approved and the communicator 73 receives the control request from the external apparatus 100. Thereafter, the controller 70 operates in the external control mode. A specific example of the information representing that acceptance of the control request is approved may be information representing that the connection terminal 21-1 is used to accept the control request. When the action mode is switched from the normal action mode to the external control mode, the communicator 73 transmits the setting information D1 to the external apparatus 100. Thereafter, the communicator 73 receives an update instruction that instructs update of the setting information D1 from the external apparatus 100 and transmits the updated setting information D1 to the external apparatus 100 in accordance with the update instruction. In the external control mode, the communicator 73 transmits operation information representing the operation of changing the settings out of the operation information received from the operation accepting section 50 to the external apparatus 100.

The first evaluator 74 evaluates whether or not the update instruction has been received from the communicator 73. The second evaluator 75 evaluates whether or not the operation of changing the settings has been performed on the operation accepting section 50. The third evaluator 76 evaluates whether or not an instruction of termination of the external control mode has been issued. In the present embodiment, when the information representing that acceptance of the control request is approved is deleted from the setting information D1, for example, when the information representing what the connection terminal 21-1 is used for is changed to information representing acceptance of a video signal, the third evaluator 76 determines that the instruction of termination of the external control mode has been issued. When the third evaluator 76 determines that the instruction of termination of the external control mode has been issued, the controller 70 updates the value of the action mode flag F1 to “0”, and the controller 70 operates in the normal action mode afterward.

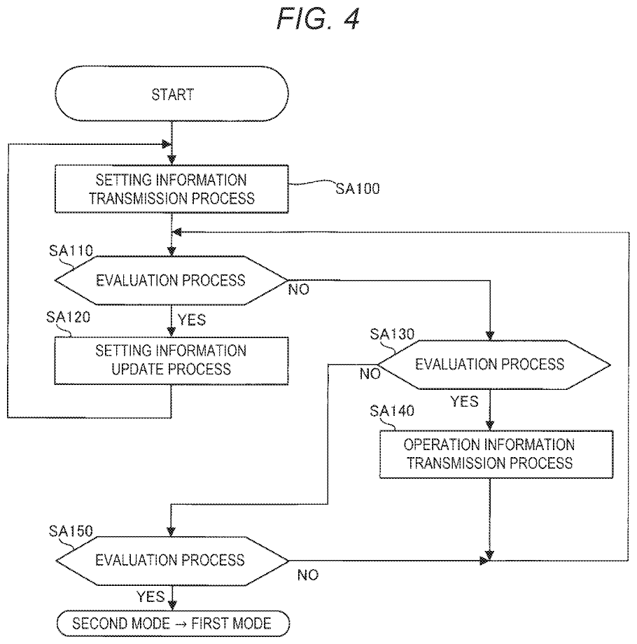

Out of the processes carried out by the controller 70 in accordance with the control program P1, the processes carried out in the normal action mode are not particularly different from the processes carried out by the related-art projector 10 in the normal action mode. The processes carried out by the controller 70 in the external control mode will therefore be primarily described below. FIG. 4 is a flowchart showing the procedure of the processes carried out in the external control mode by the controller 70 that operates in accordance with the control program P1. The processes carried out in the external control mode include a setting information transmission process SA100, an evaluation process SA110, a setting information update process SA120, an evaluation process SA130, an operation information transmission process SA140, and an evaluation process SA150, as shown in FIG. 4.

In the setting information transmission process SA100, the controller 70 functions as the communicator 73 and transmits the setting information D1 stored in the storage 60 to the external apparatus 100, which is the origin from which the control request is transmitted. In the evaluation process SA110, by which the setting information transmission process SA100 is followed, the controller 70 functions as the communicator 73 and the first evaluator 74. In the evaluation process SA110, the controller 70 evaluates whether or not the controller 70 has received the update instruction from the external apparatus 100. When the controller 70 has received the update instruction from the external apparatus 100, the evaluation result of the evaluation process SA110 is “Yes,” and the controller 70 carries out the setting information update process SA120. In contrast, when the evaluation result of the evaluation process SA110 is “No,” the controller 70 carries out the evaluation process SA130.

In the setting information update process SA120, the controller 70 functions as the updater 72 and updates the setting information D1 in accordance with the update instruction received from the external apparatus 100. When the setting information update process SA120 is completed, the controller 70 carries out the setting information transmission process SA100 again, as shown in FIG. 4. In the setting information transmission process SA100 carried out after the setting information update process SA120 is completed, the updated setting information D1 in the setting information update process SA120 is transmitted to the external apparatus 100.

In the evaluation process SA130, the controller 70 functions as the second evaluator 75 and evaluates whether or not the operation of changing the settings has been performed on the operation accepting section 50. When the evaluation result of the evaluation process SA130 is “Yes,” the controller 70 carries out the operation information transmission process SA140, then carries out the evaluation process SA110 again, and waits for reception of the update instruction. In contrast, when the evaluation result of the evaluation process SA130 is “No,” the controller 70 carries out the evaluation process SA150.

In the operation information transmission process SA140, the controller 70 functions as the communicator 73 and transmits the operation information representing operation performed on the operation accepting section 50 to the external apparatus 100. The setting changing operation performed on the operation accepting section 50 under the situation in which the controller 70 operates in the external control mode is thus transmitted to the external apparatus 100.

In the evaluation process SA150, the controller 70 functions as the third evaluator 76 and evaluates whether or not the instruction of termination of the external control mode has been issued. When the evaluation result of the evaluation process SA150 is “No,” the controller 70 carries out the evaluation process SA110 again and waits for reception of the update instruction. In contrast, when the evaluation result of the evaluation process SA150 is “Yes,” the controller 70 updates the value of the action mode flag F1 to “0” and terminates the processes in the external control mode.

The configuration of the projector 10 has been described.

### 3. Configuration of External Apparatus

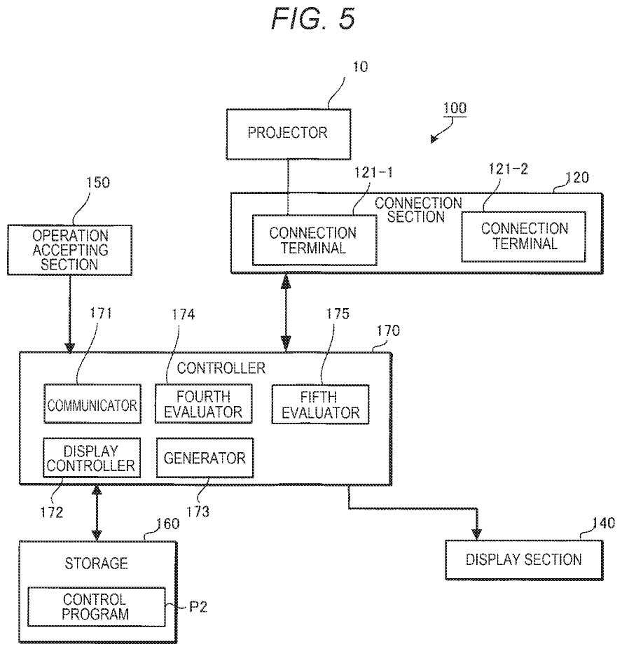

FIG. 5 is a block diagram showing an example of the hardware configuration and functional configuration of the external apparatus 100. The external apparatus 100 includes a connection section 120, a display section 140, an operation accepting section 150, a storage 160, and a controller 170, as shown in FIG. 5.

The connection section 120 has a connection terminal 121-1 and a connection terminal 121-2. The connection terminal 121-1 and the connection terminal 121-2 are each a USB terminal, as does the connection terminal 21-1. In the present embodiment, the projector 10 is connected to the connection terminal 121-1, as shown in FIG. 5.

The display section 140 includes a liquid crystal display and a circuit that drives the liquid crystal display, although not shown in detail in FIG. 5. The display section 40 displays an image under the control of the controller 170. An example of the image displayed by the display section 140 under the control of the controller 170 may be an image of the screen that allows the user to view or change the settings of the projector 10, that is, an image of the second screen described above.

The operation accepting section 150 includes a pointing device, such as a mouse, and a keyboard, although not shown in detail in FIG. 5. The operation accepting section 150 accepts the user's operation and provides operation information representing the content of the operation to the controller 170.

The storage 160 is a storage device that stores a control program P2 executed by the controller 170. Although not shown in detail in FIG. 5, the storage 160 includes a volatile storage and a nonvolatile storage, as does the storage 60. The volatile storage is used as a work area that stores information to be processed by the controller 170 and a work area where the controller 170 executes the control program P2. The nonvolatile storage stores the control program P2 in advance.

The controller 170 is a processing device having the function of controlling each portion of the external apparatus 100 and the function of processing a variety of types of information. The controller 170 includes a processor, for example, a CPU (central processing unit), as does the controller 70. The controller 170 achieves a variety of functions including functional sections that will by described later by executing the control program P2 stored in the storage 160. The controller 170 may be formed of a single processor or a plurality of processors, as is the controller 70.

When instructed by operation performed on the operation accepting section 150 to start execution of the control program P2, the controller 170 reads the control program P2 from the storage 160 and executes the control program P2. The controller 170 that operates in accordance with the control program P2 functions as a communicator 171, a display controller 172, a generator 173, a fourth evaluator 174, and a fifth evaluator 175 shown in FIG. 5.

The communicator 171 communicates with the projector 10 connected to the connection section 120. Upon sensing of the connection of the projector 10 to the connection section 120, the communicator 171 transmits the control request described above to the projector 10. The communicator 171 receives the setting information D1 and the operation information transmitted from the projector 10. The communicator 171 further transmits an update instruction generated by the generator 173, which will be described later, to the projector 10.

The display controller 172 causes the display section 140 to display a setting screen in accordance with the setting information D1 received from the communicator 171. When the projector 10 operates in the external control mode, the user can grasp the settings of the projector 10 via the setting screen displayed on the display section 140 and operate the operation accepting section 150 to change the settings of the projector 10. In the present embodiment, the control program P2 and the control program P1 are generated based on the same source code, and the screen layout of the setting screen that the display controller 172 causes the display section 140 to display is the same as the screen layout of the setting screen that the display controller 71 causes the display section 40 to display. That is, the display controller 172 causes the display section 140 to display the setting screen shown in FIG. 3. Since the control program P2 and the control program P1 are generated based on the same source code, the control program P2 does not need to be developed separately from and independently of the control program P1.

The fourth evaluator 174 evaluates whether or not the operation of changing the settings of the projector 10 has been performed. In more detail, when the operation of changing the settings of the projector 10 has been performed on the operation accepting section 150 or when the operation information representing the operation of changing the settings of the projector 10 is received via the communicator 171, the fourth evaluator 174 determines that the operation of changing the settings of the projector 10 has been performed. The generator 173 generates an update instruction in accordance with the operation of changing the settings of the projector 10. The fifth evaluator 175 evaluates whether or not the operation of instructing termination of the execution of the control program P2 has been performed on the operation accepting section 150.

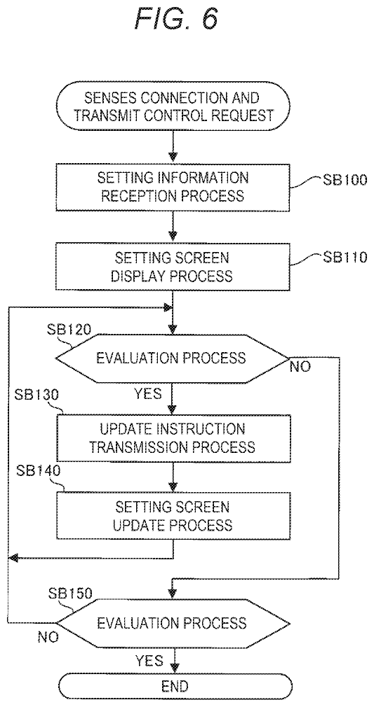

Upon sensing of the connection of the projector 10 to the connection section 120, the controller 170 that operates in accordance with the control program P2 transmits the control request to the projector 10 and then carries out the processes shown in the flowchart of FIG. 6. The processes carried out by the controller 170 in accordance with the control program P2 include a setting information reception process SB100, a setting screen display process SB110, an evaluation process SB120, an update instruction transmission process SB130, a setting screen update process SB140, and an evaluation process SB150, as shown in FIG. 6.

In the setting information reception process SB100, the controller 170 functions as the communicator 171 and receives the setting information D1 transmitted from the projector 10. In the setting screen display process SB110, by which the setting information reception process SB100 is followed, the controller 170 functions as the display controller 172 and causes the display section 140 to display the setting screen in accordance with the setting information D1 having been received in the setting information reception process SB100.

In the evaluation process SB120, by which the setting screen display process SB110 is followed, the controller 170 functions as the communicator 171 and the fourth evaluator 174 and evaluates whether or not the operation of changing the settings of the projector 10 has been performed. When the evaluation result of the evaluation process SB120 is “Yes,” the controller 170 carries out the update instruction transmission process SB130 and the setting screen update process SB140. In contrast, when the evaluation result of the evaluation process SB120 is “No,” the controller 170 carries out the evaluation process SB150.

In the update instruction transmission process SB130, the controller 170 functions as the communicator 171 and the generator 173. In more detail, in the update instruction transmission process SB130, the controller 170 generates an update instruction in accordance with the operation performed on the operation accepting section 150 or the operation indicated by the operation information received from the projector 10 and transmits the thus generated update instruction to the projector 10.

In the setting screen update process SB140, by which the update instruction transmission process SB130 is followed, the controller 170 functions as the communicator 171 and the display controller 172. In more detail, in the setting screen update process SB140, the controller 170 waits for reception of the setting information D1 having undergone the update indicated by the update instruction having been transmitted in the update instruction transmission process SB130, and upon the reception of the updated setting information D1, the controller 170 updates the content displayed on the setting screen in accordance with the updated setting information D1.

In the evaluation process SB150, the controller 170 functions as the fifth evaluator 175 and evaluates whether or not the operation of instructing termination of the execution of the control program P2 has been performed on the operation accepting section 150. When the evaluation result of the evaluation process SB150 is “No,” the controller 170 carries out the evaluation process SB120 again. In contrast, when the evaluation result of the evaluation process SB150 is “Yes,” the controller 170 terminates the execution of the control program P2.

As described above, in the display system 1 in the present embodiment, when the projector 10 operates in the external control mode, the setting information D1 is transmitted from the projector 10 to the external apparatus 100, and the external apparatus 100 displays the setting screen in accordance with the setting information D1 received from the projector 10. When the operation of changing the settings of the projector 10 is performed on the operation accepting section 50 under the situation in which the projector 10 operates in the external control mode, the projector 10 carries out the operation information transmission process SA140, and operation information representing the operation is transmitted from the projector 10 to the external apparatus 100.

Upon reception of the operation information described above, the external apparatus 100 carries out the update instruction transmission process SB130. An update instruction according to the operation indicated by the operation information described above is thus transmitted from the external apparatus 100 to the projector 10. The projector 10 then carries out the setting information update process SA120 in response to a trigger that is the reception of the update instruction described above to update the setting information D1. As described above, in the display system 1, the operation accepting section 50 accepts the operation of changing the settings of the projector 10 also when the projector 10 operates in the external control mode, and the setting information D1 can be updated in accordance with the operation, whereby the user's convenience of setting the projector 10 is improved.

In the present embodiment, when the setting information D1 is updated in the projector 10, the setting information transmission process SA100 is carried out. The updated setting information D1 is thus transmitted from the projector 10 to the external apparatus 100. Upon reception of the updated setting information D1, the external apparatus 100 carries out the setting screen update process SB140 to update the content displayed on the setting screen in accordance with the updated setting information D1. The synchronization of the setting information D1 stored in the projector 10 with the content displayed on the setting screen displayed on the display section 140 of the external apparatus 100 does not deteriorate.

### 4. Other Embodiments

The embodiment described above may be combined with any of the variations below.

(1) The projector 10 in the embodiment described above is provided with the operation accepting section 50 for accepting the user's operation in the normal action mode. Instead, a remote control that communicates with the projector 10 wirelessly or via a wire may play the role of the operation accepting section 50. Further, in the embodiment described above, the connection terminals 21-1 and 121-1 are each a USB terminal and may instead each be a terminal that connects a LAN cable. When the projector 10 is connected to the external apparatus 100 via a LAN cable, the control request, the setting information D1, the operation information, and the update instruction may be transmitted and received over communication compliant with a communication protocol, for example, IP. In the embodiment described above, the screen layout of the setting screen displayed by the display controller 172 on the display section 140 is the same as the screen layout of the setting screen displayed by the display controller 71 on the display section 40, and the two screen layouts may, of course, differ from each other.

(2) In the embodiment described above, when the operation of changing the settings of the projector 10 is performed on the operation accepting section 50 under the situation in which the projector 10 operates in the external control mode, the operation information representing the operation is transmitted from the projector 10 to the external apparatus 100. However, when a state change necessary to be displayed in the form of OSD, such as a temperature increase warning and a video signal supply source change notification, occurs in the projector 10, notification that notifies that a state change has occurred may be transmitted from the projector 10 to the external apparatus 100, and the external apparatus 100 may display information according to the notification. Further, when the settings of the projector 10 are automatically changed in accordance with the period measured, for example, with a timer, notification representing that an event that changes the settings has occurred may be transmitted from the projector 10 to the external apparatus 100 in accordance with the period measured, for example, with the timer, and the external apparatus 100 may transmit an update instruction in accordance with the notification.

(3) In the embodiment described above, the projector 10 transmits the setting information D1 to the external apparatus 100 in response to a trigger that is switching of the action mode to the external control mode or update of the setting information D1 in accordance with the update instruction. Instead, the setting information D1 may be transmitted from the projector 10 to the external apparatus 100 in response to a trigger that is sensing of connection of the external apparatus 100 to the connection section 20, and the setting information D1 may be thereafter transmitted from the projector 10 to the external apparatus 100 whenever the setting information D1 is updated irrespective of the action mode of the projector 10, that is, the normal action mode or the external control mode.

(4) In the embodiment described above, when the control request is received and the setting information D1 contains information representing that acceptance of the control request is approved, the controller 70 switches the action mode from the normal action mode to the external control mode and starts the action of the projector 10 in the external control mode. Instead, the controller 70 may start the action of the projector 10 in the external control mode in response to a trigger that is reception of the control request irrespective of whether or not the setting information D1 contains information representing that acceptance of the control request is approved.

Still instead, the controller 70 may start the action of the projector 10 in the external control mode when a predetermined condition specified in advance is satisfied and the control request is received. A first example of the predetermined condition described above may be sensing of connection of the external apparatus 100 to a specific connection terminal, for example, a USB terminal. The reason for this is that when the external apparatus 100 is not coupled to the projector 10, the projector 10 is not allowed to operate in the external control mode.

A second example of the predetermined condition described above may be sensing of a situation in which the entire first screen is not displayed on the projection surface SC. The reason for this is that the situation in which the entire first screen is not displayed on the projection surface SC makes it difficult to change the settings in the normal action mode. As a specific approach that achieves the aspect described above, it is conceivable to provide the projector 10 with an imaging section that captures an image of the projection surface SC, cause the controller 70 to evaluate whether or not an image captured with the imaging section shows the first screen, and cause the controller 70 to start the action of the projector 10 in the external control mode in response to a trigger that is reception of the control request when the controller 70 determines that the captured image does not show the first screen. The evaluation of whether or not an image captured with the imaging section shows the first screen may be made by using a known technology, such as pattern matching, as appropriate. The controller 70 may determine that the captured image does not show the first screen, of course, when the image captured with the imaging section does not show the first screen at all, and also when the captured image shows only part of the first screen.

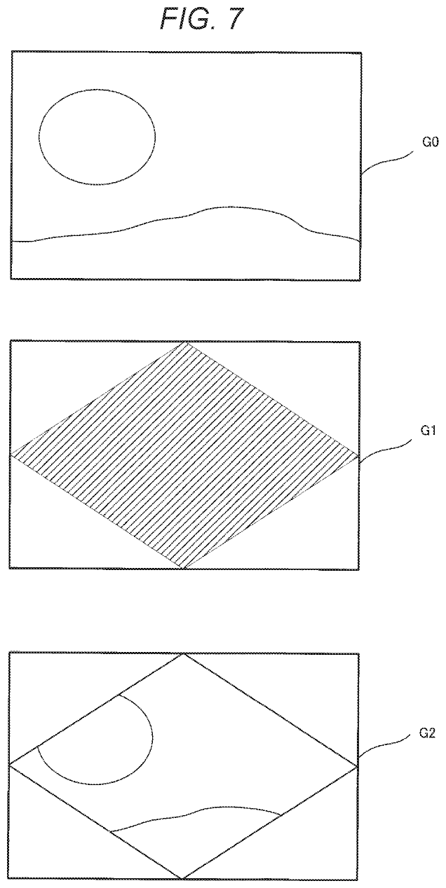

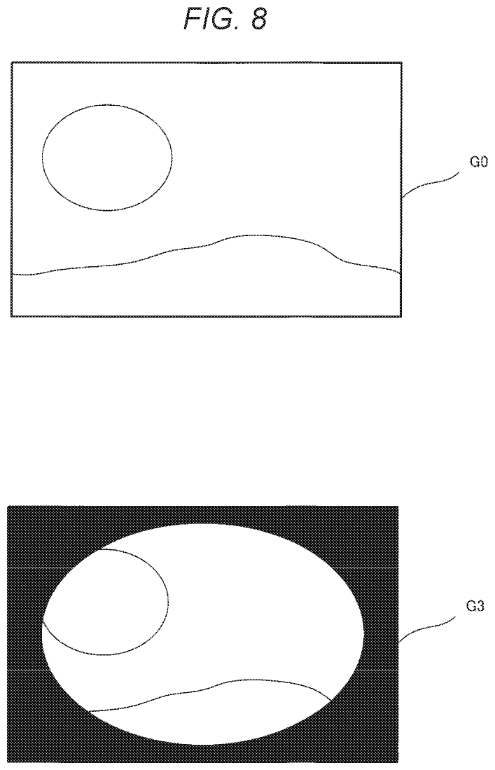

A third example of the predetermined condition described above may be sensing of a situation in which part of the first image is invisible. A specific example of the situation in which part of the first image is invisible may be a case where custom filtering is so performed that a custom filtered image G1 is superimposed on the an image G0 to form an image G2 and the image G2 is displayed on the display section 40, as shown in FIG. 7. In the custom filtered image G1 shown in FIG. 7, the display color of the hatched portion is set to be transparent, and the custom filtered image G1 is superimposed on the image G0 to form the image G2. Another specific example of the situation in which part of the first image is invisible may be a case where an image G3, which is the image G0 having a black peripheral according to the shape and size of the projection surface by using a vignette function, is projected, as shown in FIG. 8, for example, a case where the image G0 is projected on the surface of a three-dimensional object, such as a sphere, as the projection surface SC. The reason for this is that when part of the first image is invisible, such as the image G2 shown in FIG. 7 and the image G3 shown in FIG. 8, displaying an image of the first screen in such a way that the image is superimposed on the first image causes the first screen to extend off the display area, which makes it difficult to change the settings in the normal action mode.

(5) In the embodiment described above, when the instruction of termination of the external control mode is issued, the controller 70 carries out the process of switching the action mode from the external control mode to the normal action mode. The controller 70 may instead carry out the process of switching the action mode from the external control mode to the normal action mode in response to a trigger that is termination or disruption of the communication with the external apparatus 100 via the connection section 20 or sensing of detachment of the external apparatus 100 from the connection section 20.

(6) In the embodiment described above, the controller 70 of the projector 10 carries out the processes shown in the flowchart of FIG. 4, and the controller 170 of the external apparatus 100 carries out the processes shown in the flowchart of FIG. 6. However, the control method according to the present disclosure only needs to include at least a first process carried out by the projector 10 and a second process carried out by the external apparatus 100. The first process is a process carried out in the external control mode. In the first process, the projector 10 transmits the setting information D1 stored in the storage 60 to the external apparatus 100 and transmits, when operation is performed on the operation accepting section 50, the operation information representing the operation to the external apparatus 100. In the second process, the external apparatus 100 causes the display section 140 to display the second screen in accordance with the setting information D1 received from the projector 10, generates an update instruction in accordance with the operation indicated by the operation information received from the projector 10, and transmits the update instruction to the projector 10.

(7) In the embodiment described above, the display system 1 including the projector 10 and the external apparatus 100 has been described, and the projector 10 may be manufactured and sold as a standalone apparatus. The control program P1 may be distributed in the form of a computer readable recording medium, such as a flash ROM (read only memory), on which the control program P1 is written or in the form of a program downloaded via an electric communication line, such as the Internet. The reason for this is that the related-art projector is allowed to function as the projector 10 in the embodiment described above by causing the controller of the related-art projector to operate in accordance with the thus distributed control program P1. The same holds true for the control program P2. That is, the control program P2 may be distributed in the form of a computer readable recording medium on which the control program P2 is written or in the form of a program downloaded via an electric communication line. The reason for this is that a typical personal computer is allowed to function as the external apparatus 100 in the embodiment described above by causing the controller of the personal computer to operate in accordance with the thus distributed control program P2.

What is claimed is:

1. A method for controlling a display system including:
a projector that displays a first image according to a video signal outputted from an output apparatus on a projection surface and includes an operation accepting section that accepts a user's operation; and an external apparatus including a display section and coupled to the projector,
wherein the projector stores at least setting information representing a setting on display of the first image,
the projector operates in one of a first mode in which a first screen that allows the user to view or update the setting information is displayed on the projection surface in accordance with the setting information and the setting information is updated in accordance with first operation performed on the operation accepting section and a second mode in which the setting information is updated in accordance with an update instruction received from the external apparatus,
in the second mode, the projector transmits the setting information to the external apparatus, and when second operation is performed on the operation accepting section, the projector transmits operation information representing the second operation to the external apparatus, and
the external apparatus displays, in accordance with the setting information received from the projector, a second screen that allows the user to view or update the setting, generates the update instruction in accordance with the second operation indicated by the operation information received from the projector, and transmits the update instruction to the projector.

2. The method for controlling a display system according to claim 1,
wherein upon the update of the setting information in accordance with the update instruction, the projector transmits the updated setting information to the external apparatus, and
the external apparatus updates a content displayed on the second screen in accordance with the updated setting information received from the projector.

3. The method for controlling a display system according to claim 1,
wherein the external apparatus transmits a control request that prompts switching the action mode to the second mode to the projector, and
the projector starts acting in second mode in response to a trigger that is reception of the control request.

4. The method for controlling a display system according to claim 3, wherein the projector evaluates whether or not the setting information contains information representing that reception of the control request is approved, and when the projector determines that the setting information contains information representing that reception of the control request is approved, the projector starts acting in the second mode in response to a trigger that is the reception of the control request.

5. The method for controlling a display system according to claim 3,
wherein the projector includes an imaging section that captures an image of the projection surface, and
the projector evaluates whether or not an image captured by the imaging section shows the first screen, and when the projector determines that the captured image does not show the first screen, the projector starts acting in the second mode in response to a trigger that is the reception of the control request.

6. The method for controlling a display system according to claim 3, wherein the projector evaluates whether or not the first image is displayed on the projection surface with part of the first image being invisible, and when the projector determines that part of the first image is invisible, the projector starts acting in the second mode in response to a trigger that is the reception of the control request.

7. A projector comprising:
a connection section that couples an external apparatus and an output apparatus that outputs a video signal to the projector;
a display section that displays a first image according to the video signal outputted from the output apparatus connected to the connection section on a projection surface;
a storage that stores at least setting information representing a setting on display of the first image;
an operation accepting section that accepts operation of updating the setting information; and
a controller that operates in one of a first mode in which a first screen that allows a user to view or update the setting information is displayed on the projection surface and the setting information is updated in accordance with first operation accepted by the operation accepting section and a second mode in which the setting information is updated in accordance with an update instruction received from the external apparatus,
wherein in the second mode, the controller transmits the setting information to the external apparatus to cause the external apparatus to display a second screen that allows the user to view or update the setting information, and when second operation is performed on the operation accepting section, the controller transmits operation information representing the second operation to the external apparatus to cause the external apparatus to generate the update instruction according to the second operation.
